(19) United States
(12) Patent Application Publication
(10) Pub. No.: US 2021/0172509 A1
(43) Pub. Date: Jun. 10, 2021

(54) TRANSMISSION SERIES

(71) Applicants: ZF Friedrichshafen AG, Friedrichshafen (DE); ZF Wind Power Antwerpen N.V., Lommel (BE)

(72) Inventor: Warren Smook, Huldenberg (BE)

(21) Appl. No.: 17/254,301

(22) PCT Filed: May 23, 2019
(86) PCT No.: PCT/EP2019/063273

§ 371 Date: Dec. 21, 2020

(30) Foreign Application Priority Data
Jun. 21, 2018 (DE) 10 2018 210 131.0

(51) Int. Cl. F16H 57/033; F16H 1/46

(52) U.S. Cl. CPC F16H 57/033; F16H 1/46

(57) ABSTRACT

A series of transmissions includes a first transmission and a second transmission. The transmissions each have a first planetary stage and a second planetary stage. The first planetary stage and the second planetary stage each have a ring gear, a planetary carrier with one or more planetary gears and a sun gear. A width of the planetary gears of the first planetary stage of the first transmission is smaller than a width of the planetary gears of the first planetary stage of the second transmission. A width of the planetary gears of the second planetary stage of the first transmission is smaller than a width of the planetary gears of the second planetary stage of the second transmission.

### CROSS REFERENCE TO RELATED APPLICATIONS

This application is a U.S. National Phase Application under 35 U.S.C. § 371 of International Application No. PCT/EP2019/063273, filed on May 23, 2019, and claims benefit to German Patent Application No. DE 10 2018 210 131.0, filed on Jun. 21, 2018. The International Application was published in German on Dec. 26, 2019 as WO 2019/242976 under PCT Article 21(2).

### FIELD

The invention relates to a series of transmissions that each have a first planetary stage and a second planetary stage.

### BACKGROUND

The construction and manufacture of transmissions requires a considerable effort in terms of investment and resources. Many providers therefore strive to cover as many applications as possible with a single transmission type. However, this leads to the transmission being overdimensioned in applications with low loads. An overdimensioned transmission in turn offers potential for cost savings.

In view of this background information, the development of a transmission series seems appropriate. On the one hand, a production series makes it possible to use components in different transmissions of the series. On the other hand, the transmissions of the series can be adapted to specific applications. Both factors have a cost-saving effect.

In the field of wind turbines, however, conventional types of transmission series could not be established so far. The use of series is difficult here, since the plant manufacturers specify highly deviating interfaces between the system and the transmission. Furthermore, a strongly varying band width of load cases has to be covered.

The publication DE 100 28 046 A1 discloses a series of revolving transmissions whose transmissions differ by varying tooth widths. The transmissions may be executed as multi-stage. However, the variation in the tooth widths affects only a single transmission stage.

### SUMMARY

In an embodiment, the present invention provides a series of transmissions. The series includes a first transmission and a second transmission. The transmissions each have a first planetary stage and a second planetary stage. The first planetary stage and the second planetary stage each have a ring gear, a planetary carrier with one or more planetary gears and a sun gear. A width of the planetary gears of the first planetary stage of the first transmission is smaller than a width of the planetary gears of the first planetary stage of the second transmission. A width of the planetary gears of the second planetary stage of the first transmission is smaller than a width of the planetary gears of the second planetary stage of the second transmission.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a first transmission diagram;

FIG. 2 shows a second transmission diagram; and

FIG. 3 shows a transmission series.

### DETAILED DESCRIPTION

The present disclosure provides transmissions for wind turbines that avoid inherent disadvantages of solutions known from the prior art. In particular, costs should be reduced without impairing technical properties.

A series is defined as a plurality of individual devices. The series according to the present disclosure consists of transmissions, preferably transmissions for wind turbines, and comprises at least one first transmission and one second transmission.

Each transmission of the series has a first planetary stage and a second planetary stage. The second planetary stage is connected downstream from the first planetary stage. This means that the first planetary stage is arranged in a torque flow from an input to an output of the transmission upstream of the second planetary stage. A torque is transmitted from the first planetary stage to the second planetary stage.

A planetary stage is a transmission stage with a ring gear, a sun gear, a planetary carrier and one or more, preferably structurally identical, planetary gears. The planetary gears are rotatably supported in the planetary carrier and respectively mesh with the ring gear and/or the sun gear. Two of the three components sun gear, planetary carrier and ring gear are rotatably mounted. The third component is arranged to be rotationally fixed.

The width of the planetary gears of the first planetary stage of the first transmission is smaller than the width of the planetary gears of the first planetary stage of the second transmission.

The width of a gear is a designation for the width of its teeth. This in turn refers to the spatial extent of the teeth in the axial direction, that is to say along an axis of rotation of the gear. This is based on the assumption that all teeth of the gear are of equal width.

According to the present disclosure, the width of the planetary gears of the second planetary stage of the first transmission is also smaller than the width of the planetary gears of the second planetary stage of the second transmission. As a result, the transmissions of the series can be adapted particularly well to the occurring load cases. In particular, an excessively powerful design of individual planetary stages, which is accompanied by unnecessarily high costs, can be avoided.

In a preferred refinement, the number of planetary gears of the first planetary stage of the first transmission corresponds to the number of planetary gears of the first planetary stage of the second transmission. This makes it possible to use identical planetary carriers in the first planetary stage of the first transmission and in the first planetary stage of the second transmission.

In general, two components are structurally identical if they are the same apart from manufacturing tolerances. In particular, all physical parameters of the components, such as the dimensions or the material properties, coincide within the scope of manufacturing tolerances. Components of the same type are characterized in that they are interchangeable with one another.

In a preferred refinement, the number of planetary gears of the second planetary stage of the first transmission also corresponds to the number of planetary gears of the second planetary stage of the second transmission. Identical planetary carriers can thereby be realized in the second planetary stage of the first transmission and in the second planetary stage of the second transmission.

In a further preferred refinement, the number of planetary gears of the first planetary stage of the first transmission corresponds to the number of planetary gears of the second planetary stage of the first transmission. The same applies preferably to the number of planetary gears of the first planetary stage of the second transmission and the number of planetary gears of the second planetary stage of the second transmission.

In addition to the first transmission and the second transmission, the series is preferably further developed with a third transmission and a fourth transmission. The third transmission and the fourth transmission also each have a first planetary stage and a second planetary stage. The width of the planetary gears of the first planetary stage of the third transmission is smaller than the width of the planetary gears of the first planetary stage of the fourth transmission. Similarly, the width of the planetary gears of the second planetary stage of the third transmission is smaller than the width of the planetary gears of the second planetary stage of the fourth transmission.

In a preferred refinement, the width of the planetary gears of the first planetary stage of the third transmission corresponds to the width of the planetary gears of the first planetary stage of the first transmission. Thus, for example, the sun gears and the ring gears of the first planetary stages of the first transmission and of the third transmission can be configured identically. In particular, it is possible to use identical planetary gears in the first planetary stages of the first transmission and of the third transmission.

In a preferred refinement, the width of the planetary gears of the second planetary stage of the third transmission corresponds to the width of the planetary gears of the second planetary stage of the first transmission. This allows the use of identical ring gears, sun gears and in particular planetary gears in the second planetary stages of the first transmission and of the third transmission.

In a preferred refinement, the width of the planetary gears of the first planetary stage of the fourth transmission corresponds to the width of the planetary gears of the first planetary stage of the second transmission. In this way, identical ring gears, sun gears and in particular planetary gears can be used in the first planetary stages of the second transmission and of the fourth transmission.

Finally, in a preferred refinement, the width of the planetary gears of the second planetary stage of the fourth transmission corresponds to the width of the planetary gears of the second planetary stage of the second transmission, so that once again identical ring gears, sun gears and especially planetary gears can be used.

In a further preferred refinement, the number of planetary gears of the first planetary stage of the third transmission corresponds to the number of planetary gears of the first planetary stage of the fourth transmission. Consequently, identical planetary carriers can be used for the first planetary stages of the third transmission and of the fourth transmission.

In a preferred refinement, the number of planetary gears of the second planetary stage of the third transmission and the number of planetary gears of the second planet stage of the fourth transmission also coincide, so that identical planetary gears can be used in the second planetary stages of the third transmission and of the fourth transmission.

In a preferred refinement, the number of planetary gears of the first planetary stage of the third transmission corresponds to the number of planetary gears of the second planetary stage of the third transmission. The same applies preferably to the number of planetary gears of the first stage of the fourth transmission and the number of planetary gears of the second planetary stage of the fourth transmission.

In contrast, the number of planetary gears of the first planetary stage of the third transmission in a preferred refinement is greater than the number of planetary gears of the first planetary stage of the first transmission. Similarly, in preferred refinements, the number of planetary gears of the second planetary stage of the third transmission is greater than the number of planetary gears of the second planetary stage of the first transmission, the number of planetary gears of the first planetary stage of the fourth transmission is greater than the number of planetary gears of the first planetary stage of the third transmission and/or the number of planetary gears of the second planetary stage of the fourth transmission is greater than the number of planetary gears of the second planetary stage of the second transmission.

In a preferred refinement, the transmissions of the series have, in addition to the first planetary stage and the second planetary stage, a third transmission stage, which is preferably designed as a planetary stage. This is preferably connected downstream of the second planetary stage; i.e., is found in a torque flow which runs from the input to the output of the transmission downstream of the second planetary stage. In particular, the second planetary stage can be arranged axially between the first planetary stage and the third transmission stage.

In preferred refinements, the third transmission stages of the first transmission and of the second transmission and/or the third transmission stages of the third transmission and of the fourth transmission are identical in their design.

Preferred exemplary embodiments of the invention are shown in the figures. Here, matching reference numbers indicate identical or functionally identical features.

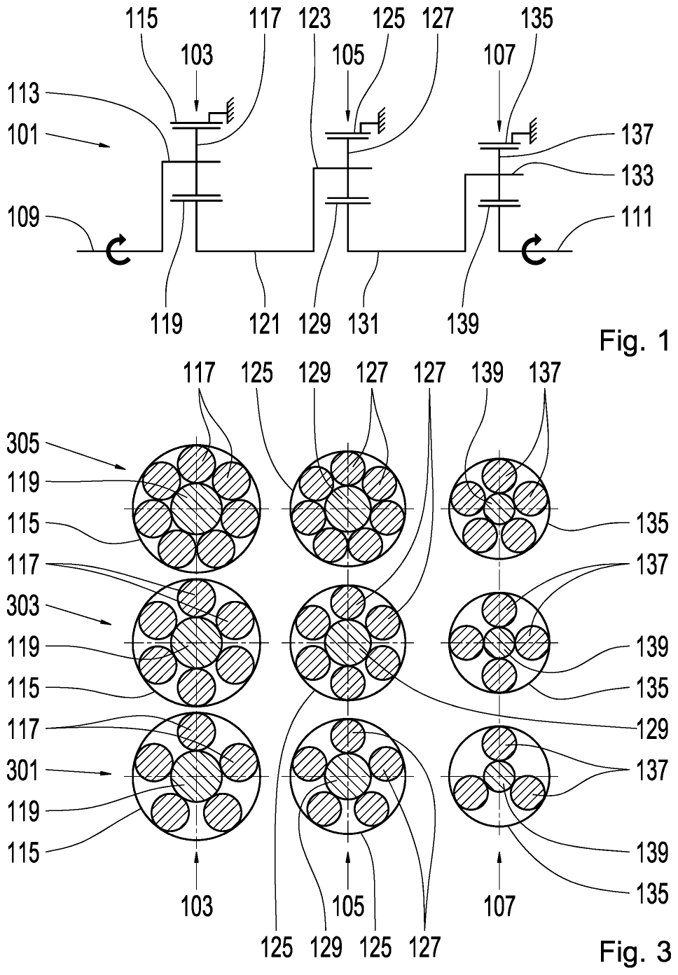

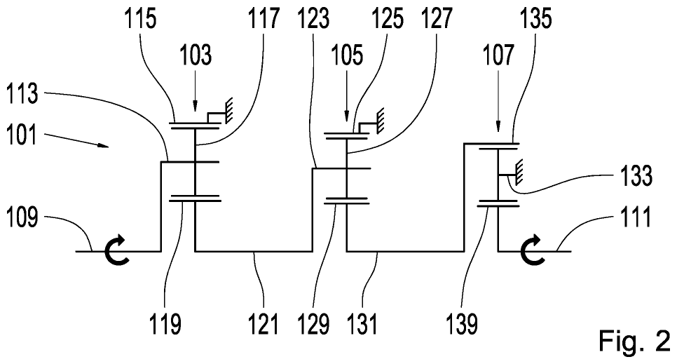

The diagrams in FIGS. 1 and 2 represent the transmission 101 with a first planetary stage 103, a second planetary stage 105, and a third planetary stage 107. The transmission 101 further has an input shaft 109 and an output shaft 111.

The input shaft 109 is non-rotatably connected to a rotatable planetary carrier 113 of the first planetary stage 103. The first planetary stage 103 also has a ring gear 115, planetary gears 117 and a sun gear 119. The planetary gears 117 are rotatably supported in the planetary carrier 113 and mesh with the ring gear 115 and the sun gear 119. The ring gear 115 is arranged in a rotationally fixed manner and the sun gear 119 is rotatable.

Via a first intermediate shaft 121, the sun gear 119 of the first planetary stage 103 is connected non-rotatably to a rotatable planetary carrier 123 of the second planetary stage 105. The design of the second planetary stage 105 corresponds to the design of the first planetary stage 103. Correspondingly, the second planetary stage 105 has a rotationally fixed ring gear 125, planetary gears 127 that are rotatably supported in the planetary carrier 123, and a rotatable sun gear 129. The planet gears 127 are rotatably supported within the planetary carrier 123 and mesh with the ring gear 125 and the sun gear 129.

In accordance with FIG. 1, the sun gear 129 of the second planetary stage 105 is connected to a planetary carrier 133 of the third planetary stage 107 in a non-rotatable manner via an intermediate shaft 131. The design of the third planetary stage 107 according to FIG. 1 corresponds to the design of the first planetary stage 103 and the second planetary stage 105. Accordingly, the third planetary stage 107 has a rotationally fixed ring gear 135, planetary gears 137 and a rotatable sun gear 139. The planetary gears 137 are rotatably supported in the planetary carrier 133 and mesh with the ring gear 135 and the sun gear 139. The sun gear 139 is non-rotatably connected with the output shaft 111.

The transmission 101 shown in FIG. 2 differs from the transmission shown in FIG. 1 by the design of the third planetary stage 107. Here, the ring gear 135 is rotatably supported and connected to the sun gear 129 of the second planetary stage 105 in a non-rotatable manner via the second intermediate shaft 131. The planetary carrier 133 is arranged in a non-rotatable manner.

FIG. 3 outlines a transmission series. The transmissions contained in the series can be constructed approximately as shown in FIG. 1 or 2.

The series comprises six transmissions with three different mountings 301, 303, 305 of planetary gears 117, 127, 137. From each mounting 301, 303, 305, varying the width of the planetary gears 117, 127 of the first planetary stage 103 and the second planetary stage 105, results in two different transmissions.

The first mounting 301 provides a transmission 101 having five planetary gears 117 in the first planetary stage 103, five planetary gears 127 in the second planetary stage 105 and three planetary gears 137 in the third planetary stage 107. The set 301 includes two transmissions 101 with the first mounting 301. These differ by the width of the planetary gears 117 of the first planetary stage 103 and the planetary gears 127 of the second planetary stage 105 such that both the planetary gears 117 of the first planetary stage 103 and the planetary gears 127 of the second planetary stage 105 have a narrower design in one of the two transmissions than they have in the other. The third planetary stages 107 of the two transmissions are identical in construction.

The second mounting 303 provides a transmission 101 having six planetary gears 117 in the first planetary stage 103, six planetary gears 127 in the second planetary stage 105, and four planetary gears 137 in the third planetary stage 107. The set 301 contains two transmissions 101 with the second mounting 303. These differ by the width of the planetary gears 117 of the first planetary stage 103 and the planetary gears 127 of the second planetary stage 105 such that both the planetary gears 117 of the first planetary stage 103 and the planetary gears 127 of the second planetary stage 105 have a narrower design in one of the two transmissions than they have in the other. The third planetary stages 107 of the two transmissions are identical in construction.

The third mounting 305 provides a transmission 101 having seven planetary gears 117 in the first planetary stage 103, seven planetary gears 127 in the second planetary stage 105, and five planetary gears 137 in the third planetary stage 107. The set 301 includes two transmissions 101 with the third mounting 305. These differ by the width of the planetary gears 117 of the first planetary stage 103 and the planetary gears 127 of the second planetary stage 105 such that both the planetary gears 117 of the first planetary stage 103 and the planetary gears 127 of the second planetary stage 105 have a narrower design in one of the two transmissions than they have in the other. The third planetary stages 107 of the two transmissions are identical in construction.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

101 Transmission

103 First planetary stage

105 Second planetary stage

107 Third planetary stage

109 Input shaft

111 Output shaft

113 Planetary carrier

115 Ring gear

117 Planetary gear

119 Sun gear

121 Intermediate shaft

123 Planetary carrier

125 Ring gear

127 Planetary gear

129 Sun gear

131 Intermediate shaft

133 Planetary carrier

135 Ring gear

137 Planetary gear

139 Sun gear

301 First mounting

303 Second mounting

305 Third mounting

1. A series of transmissions, comprising:
a first transmission; and
a second transmission;
wherein:
the transmissions each have a first planetary stage and a second planetary stage;
the first planetary stage and the second planetary stage each have a ring gear, a planetary carrier with one or more planetary gears and a sun gear; and
a width of the planetary gears of the first planetary stage of the first transmission is smaller than a width of the planetary gears of the first planetary stage of the second transmission;
a width of the planetary gears of the second planetary stage of the first transmission is smaller than a width of the planetary gears of the second planetary stage of the second transmission.

2. The series according to claim 1, wherein a number of planetary gears of the first planetary stage of the first transmission and a number of planetary gears of the first planetary stage of the second transmission matches.

3. The series according to claim 1, wherein a number of planetary gears of the second planetary stage of the first transmission and a number of planetary gears of the second planetary stage of the second transmission matches.

4. The series according to claim 1, wherein a number of planetary gears of the first planetary stage of the first transmission and a number of planetary gears of the second planetary stage of the first transmission matches.

5. The series according to claim 1, wherein a number of planetary gears of the first planetary stage of the second transmission and a number of planetary gears of the second planetary stage of the second transmission matches.

6. The series according to claim 1, further comprising:
a third transmission; and
a fourth transmission;
wherein
the third and fourth transmissions each have a first planetary stage and a second planetary stage;
the first planetary stage and the second planetary stage each have a ring gear, a planetary carrier with one or more planetary gears, and a sun gear;
a width of the planetary gears of the first planetary stage of the third transmission is smaller than a width of the planetary gears of the first planetary stage of the fourth transmission; and
a width of the planetary gears of the second planetary stage of the third transmission is smaller than a width of the planetary gears of the second planetary stage of the fourth transmission.

7. The series according to claim 6, wherein a width of the planetary gears of the first planetary stage of the third transmission corresponds to a width of the planetary gears of the first planetary stage of the first transmission.

8. The series according to claim 6, wherein, a width of the planetary gears of the second planetary stage of the third transmission corresponds to a width of the planetary gears of the second planetary stage of the first transmission.

9. The series according to claim 6, wherein a width of the planetary gears of the first planetary stage of the fourth transmission corresponds to a width of the planetary gears of the first planetary stage of the second transmission.

10. The series according to claim 6, wherein a width of the planetary gears of the second planetary stage of the fourth transmission corresponds to a width of the planetary gears of the second planetary stage of the second transmission.

11. The series according to claim 6, wherein a number of planetary gears of the first planetary stage of the third transmission and a number of planetary gears of the first planetary stage of the fourth transmission matches.

12. The series according to claim 6, wherein a number of planetary gears of the second planetary stage of the third transmission and a number of planetary gears of the second planetary stage of the fourth transmission matches.

13. The series according to claim 6, wherein a number of planetary gears of the first planetary stage of the third transmission and a number of planetary gears of the second planetary stage of the third transmission matches.

14. The series according to claim 6, wherein a number of planetary gears of the first planetary stage of the fourth transmission and a number of planetary gears of the second planetary stage of the fourth transmission matches.

15. The series according to claim 6, wherein a number of planetary gears of the first planetary stage of the third transmission is greater than a number of planetary gears of the first planetary stage of the first transmission

16. The series according to claim 6, wherein a number of planetary gears of the second planetary stage of the third transmission is greater than a number of planetary gears of the second planetary stage of the first transmission.

17. The series according to claim 6, wherein a number of planetary gears of the first planetary stage of the fourth transmission is greater than a number of planetary gears of the first planetary stage of the third transmission.

18. The series according to claim 6, wherein a number of planetary gears of the second planetary stage of the fourth transmission is greater than a number of planetary gears of the second planetary stage of the second transmission.

19. The series according to claim 1, wherein the gears each have a third gear stage.
